(19) United States
(12) Patent Application Publication
(10) Pub. No.: US 2003/0079087 A1
(43) Pub. Date: Apr. 24, 2003

(54) Cache memory control unit and method

(75) Inventor: Atsushi Kuwata, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/270,124

(22) Filed: Oct. 15, 2002

(30) Foreign Application Priority Data
Oct. 19, 2001 (JP) 322308/2001

(51) Int. Cl. G06F 12/00

(52) U.S. Cl. 711/136; 711/134; 711/114

(57) ABSTRACT

A cache memory control unit and a cache memory control' method according to the present invention avoids a problem that, when the access frequency of one host is low and the access frequency of another host is high, frequently accessed data pages out less frequently accessed data. A controller includes a function to allocate, in the cache memory, individual cache pages to each access type and to allocate common cache pages regardless of the access type, a function to execute LRU control for each of the individual cache pages and the common cache pages, and a function to load data, which is paged out from the individual cache pages, into the common cache pages. The access type is classified according to a port via which access is made.

### BACKGROUND OF THE INVENTION

1. Field of the Intention

The present invention relates to a cache memory control unit and a cache memory control method that are used for a small-capacity, high-speed cache memory holding data, which is stored in a large-capacity, low-speed storage unit but is frequently accessed by a computer, and that performs LRU control for the cache memory. In the description below, a host computer is abbreviated to “a host”, and an application program to “an application.

2. Description of the Related Art

A standard disk array has the disk cache function installed. This disk cache function stores frequently accessed disk drive data in the cache memory to eliminate disk drive mechanical operation for speedy response. The cache memory has a capacity smaller than that of the total capacity of the disk drive. Therefore, when data not stored in the cache memory is accessed, it is necessary to page out data from the cache memory to allocate space for the accessed data. The LRU (Least Recently Used) control is usually used as the method to do this operation. The LRU control pages out the least recently accessed data. For better efficiency, the cache pages are always managed in the cache memory in order of access.

On the other hand, the SAN (Storage Area Network) technology has become used, in many cases, to connect a plurality of hosts to a disk array to allow the hosts to share the disk array. A disk array stores data shared by the plurality of hosts and data owned by individual hosts. A multi-port disk array is configured in one of the following two: a configuration in which each host has the disk cache function and a configuration in which a plurality of hosts share the disk cache function. The Japanese Patent Laid-Open Publication No. Hei 11-327811 discloses a configuration in which each host has the disk cache function, while the Japanese Patent Laid-Open Publication No. Hei 11-224164 discloses a configuration in which the disk cache function is shared by a plurality of hosts.

FIG. 6 shows a disk array in which each host has the disk cache function individually. A disk array 60 comprises ports 641 and 642, controllers 631 and 632, cache memories 651 and 652, and a physical disk 661. The controllers 631 and 632, each connected to separate hosts 611 and 612 respectively via the ports 641 and 642, control data transfer according to a command request from the hosts 611 and 612. In the hosts 611 and 612, applications 621 and 622 are running.

However, the disk array 60 has the following problem that the cache memories 651 and 652 become wasteful. First, when data shared by the hosts 611 and 612 is accessed via the ports 641 and 642, the same data is duplicated in the cache memories 651 and 652. Second, when one of the ports 641 and 642 is used less frequently, the cache memory 651 or 652 corresponding to the less frequently used port is used less frequently. For example, when the port 641 is used less frequently, the cache memory 651 is used less frequently.

FIG. 7 shows a disk array in which the two hosts share the disk cache function. A disk array 10′ comprises ports 141 and 142, controllers 131′ and 132′, a cache memory 151, and a physical disk 161. The controllers 131′ and 132′, each connected to separate hosts 111 and 112 via the port 141 and 142 respectively, control data transfer according to a command request from the hosts 111 and 112. The physical disk 161 stores individual data 171 and 172 and shared data 173. The individual data 171 and 172 is data accessed by the applications 121 and 122 running on the hosts 111 and 112, respectively.

The disk cache function in accordance with this method is advantageous in that only one copy of shared data is needed in the cache memory 151 and in that the full capacity of the cache memory 151 may be utilized even if there is a less frequently used port 141 or 142. Therefore, a large disk array with a large number of ports usually uses this configuration in which the disk cache function is shared.

However, a problem in the configuration in which the disk cache function is shared is that, if there is a difference in data usage frequency among hosts, the individual data accessed by a less frequently used host always results in a cache miss.

Suppose that, in FIG. 7, the host 111 continuously accesses the individual data 171 and that the host 112 accesses the individual data 172, for example, once an hour. In this case, the access from the host 111 gives a normal hit ratio, that is, average performance. On the other hand, the access from the host 112 gives cache-miss performance (access performance that is given when a cache miss occurs) each time the access is made because data accessed one hour before is already paged out. Because access performance is generally very low when a cache miss occurs, the access speed appears very low if no hit occurs. The average performance of the overall disk array 10′ is acceptable in this case. However, it appears to the host 112 that all access speeds are significantly lower than the average-performance access speed; in the worst case, the operation of the application 122 may be affected.

### SUMMARY OF THE INVENTION

It is an object of the present invention to provide a cache memory control unit and control method that can avoid a problem that, when the access frequency of one host is low and the access frequency of another host is high, the high-frequency access pages out data that is accessed less frequently.

A cache memory control unit according to the present invention is used for a small-capacity, high-speed cache memory holding data, which is stored in a large-capacity, low-speed storage unit but is frequently accessed by a computer, and executes LRU control for the cache memory. The cache memory control unit according to the present invention comprises means for allocating, in the cache memory, individual cache pages to each access type and allocating common cache pages regardless of the access type; means for executing the LRU control for each of the individual cache pages and the common cache pages; and means for loading data, which is paged out from the individual cache pages, into the common cache pages.

The access type is classified preferably according to a port via which data is accessed. The access type is classified preferably according to a storage space in the storage unit to which access is made.

The cache memory control unit according to the present invention is preferably a cache memory control unit

wherein the individual cache pages and the common cache pages each form an LRU link in which pages, beginning with a page pointed to by an MRU pointer and ending with a page pointed to by an LRU pointer, are connected via pointers, the MRU pointer pointing to a most recently accessed cache page in the LRU link, the LRU pointer pointing to a least recently accessed cache page, and

wherein, when requested data results in a cache miss, a cache page pointed to by the LRU pointer of a common link is paged out and a cache page, to which the requested data is allocated, is placed into a position pointed to by the MRU pointer of the LRU link of corresponding individual cache pages.

When a number of linked cache pages of each port exceeds a number of cache pages predetermined for the port, an excess number of cache pages is preferably removed from a position pointed to by the LRU pointer and placed into a position pointed to by the MRU pointer of the common cache pages.

When a number of linked cache pages of each storage space exceeds a number of cache pages predetermined for the storage space, an excess number of cache pages is preferably removed from a position pointed to by the LRU pointer and placed into a position pointed to by the MRU pointer of the common cache pages.

The storage unit is preferably a disk array.

A cache memory control method according to the present invention is used for a small-capacity, high-speed cache memory holding data, which is stored in a large-capacity, low-speed storage unit but is frequently accessed by a computer, and executes LRU control for the cache memory.

The cache memory control method according to the present invention comprises the steps of:

(a) allocating, in the cache memory, individual cache pages to each access type and allocating common cache pages regardless of the access type;

(b) executing the LRU control for each of the individual cache pages and the common cache pages; and

(c) loading data, which is paged out from the individual cache pages, into the common cache pages.

The access type is classified preferably according to a port via which data is accessed. The access type is classified preferably according to a storage space in the storage unit to which access is made.

The cache memory control method according to the present invention is preferably a cache memory control method

wherein the individual cache pages and the common cache pages each form an LRU link in which pages, beginning with a page pointed to by an MRU pointer and ending with a page pointed to by an LRU pointer, are connected via pointers, the MRU pointer pointing to a most recently accessed cache page in the LRU link, the LRU pointer pointing to a least recently accessed cache page, and

wherein, when requested data results in a cache miss, the step (c) comprises the steps of paging out a cache page pointed to by the LRU pointer of a common link; and placing a cache page, to which the requested data is allocated, into a position pointed to by the MRU pointer of the LRU link of corresponding individual cache pages.

When a number of linked cache pages of each port exceeds a number of cache pages predetermined for the port, the step (c) preferably comprises the steps of removing an excess number of cache pages from a position pointed to by the LRU pointer; and placing the cache page into a position pointed to by the MRU pointer of the common cache pages.

When a number of linked cache pages of each storage space exceeds a number of cache pages predetermined for the storage space, the step (c) preferably comprises the steps of removing an excess number of cache pages from a position pointed to by the LRU pointer; and placing the cache page into a position pointed to by the MRU pointer of the common cache pages. The storage unit is preferably a disk array. As described above, the cache memory control method according to the present invention is used for the cache memory control unit according to the present invention.

In other words, the cache memory control unit according to the present invention includes means for setting a minimum allocation capacity for cache pages to be used for a specific access. The specific access refers to access via a specific port or to access to a specific logical disk. The minimum capacity that is set for a specific access is a threshold that, even when the frequency of the access is low, prevents other high-frequency accesses from paging out cache pages for the access type when the allocation amount of cache pages for that access falls below the threshold. More specifically, the cache memory control unit according to the present invention provides one common LRU link, which is used as the LRU link for executing page-out control, and a plurality of dedicated LRU links, one for each access type.

For example, the cache memory control unit has a cache memory area for setting the minimum number of pages of a first port dedicated link and an area for setting the minimum number of pages of a second port dedicated link. In each of those areas, the minimum number of cache pages to be allocated for use in access via the port is set. For the minimum number of pages of a first port dedicated link, the two areas, one for a first port dedicated link MRU pointer and the other for a first port dedicated link LRU pointer; are provided to configure the first port dedicated link. A second port dedicated link may also be configured in the same manner.

Alternatively, a setting area is provided for each logical disk and, in this area, the minimum number of cache pages to be used for access to the logical disk is set. In this case, a dedicated link may also be configured for each logical disk.

It is an object of the present invention to avoid a problem that, when the access frequency of one host is low and the access frequency of another host is high, the high-frequency access pages out data that is accessed less frequently. When this condition occurs, the host that accesses data less frequently always gives a cache-miss performance and therefore the access speed appears extremely lower than that corresponding to the performance proper to the host although there is no problem with the average performance of the whole unit. The present invention ensures a specific amount of cache, even when the access frequency of one host is lower than that of another host, to maintain a hit ratio.

### BRIEF DESCRIPTION OF THE DRAWINGS

The novel features believed characteristic of the invention are set forth in the appended claims. The invention itself, however, as well as other features and advantages thereof, will be best understood by reference to the detailed description which follows, read in conjunction with the accompanying, wherein:

FIG. 1 is a block diagram showing a first embodiment of a cache memory control unit according to the present invention;

FIG. 2 is a block diagram showing an example of the internal logical configuration of cache memory managed by the cache memory control unit shown in FIG. 1;

FIG. 3 is a flowchart showing an example of the operation of the cache memory control unit shown in FIG. 1;

FIG. 4 is a block diagram showing a second embodiment of a cache memory control unit according to the present invention;

FIG. 5 is a block diagram showing an example of the internal logical configuration of cache memory managed by the cache memory control unit shown in FIG. 4;

FIG. 6 is a block diagram showing a first example of the conventional technology;

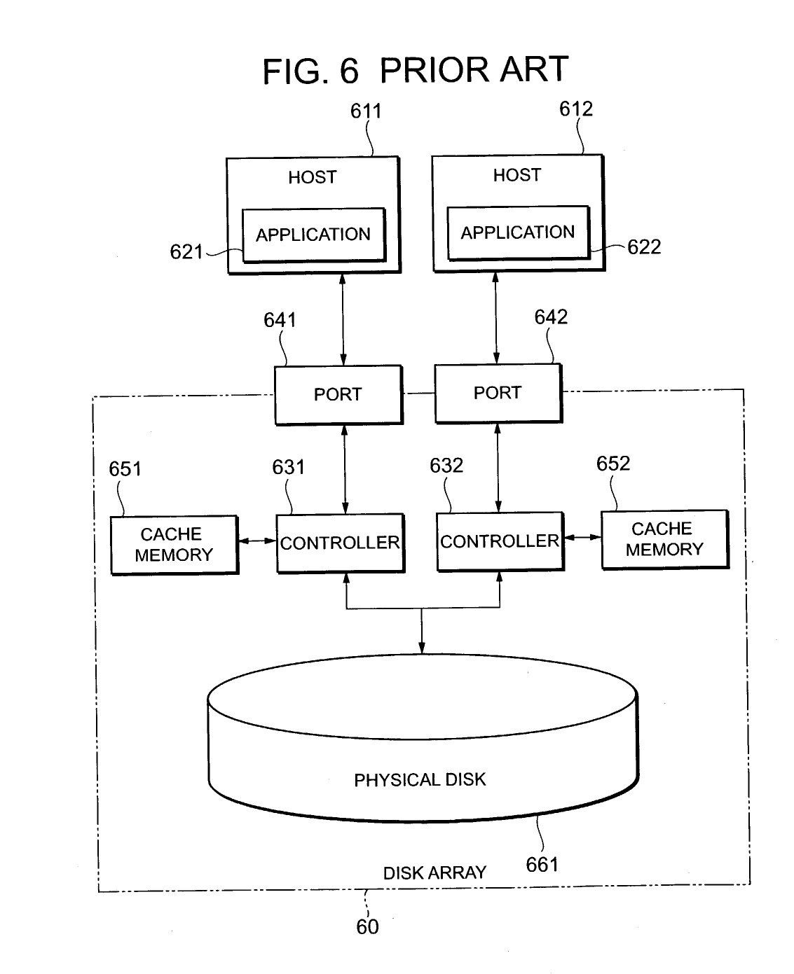

FIG. 7 is a block diagram showing a second example of the conventional technology; and

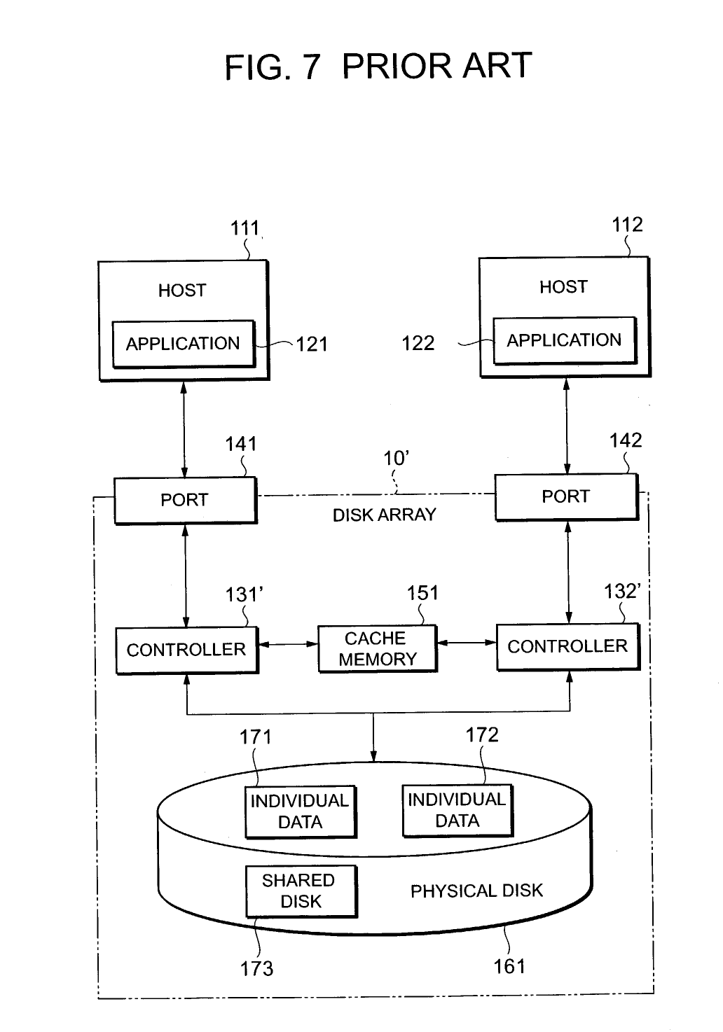

FIG. 8 is a block diagram showing an example of the internal configuration of the controller of the cache memory control unit shown in FIG. 1.

### DETAILED DESCRIPTION OF THE PREFERRED EMBODIMENTS

Some embodiments of a cache memory control unit and control method according to the present invention will be described below. Note that an embodiment of the cache memory control method according to the present invention will be described at the same time an embodiment of the cache memory control unit according to the present invention is described.

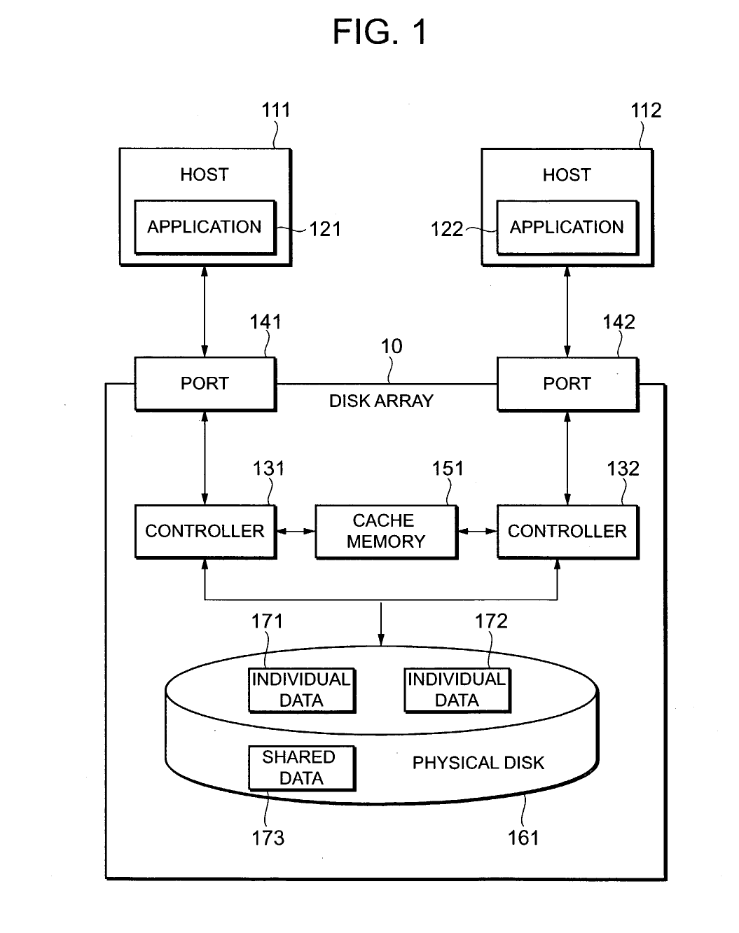

FIG. 1 is a block diagram showing a first embodiment of the cache memory control unit according to the present invention. The following describes the cache memory control unit by referring to this diagram.

The cache memory control unit in this embodiment is implemented by a program stored in controllers 131 and 132. The controllers 131 and 132 are used for a small-capacity, high-speed cache memory 151 holding data, which is stored in a large-capacity, low-speed physical disk 161 but is accessed frequently by hosts 111 and 112, and executes LRU control for the cache memory 151. The controllers 131 and 132 each have the following three functions: function to allocate, in the cache memory 151, individual cache pages for each access type as well as common cache pages regardless of access type, function to execute LRU control for individual cache pages and common cache pages, and function to load data, paged out from individual cache pages, into common cache pages. The access type is classified into access made via the port 141 and access made via the port 142.

A disk array 10 comprises ports 141 and 142, the controllers 131 and 132, cache memory 151, and physical disk 161.

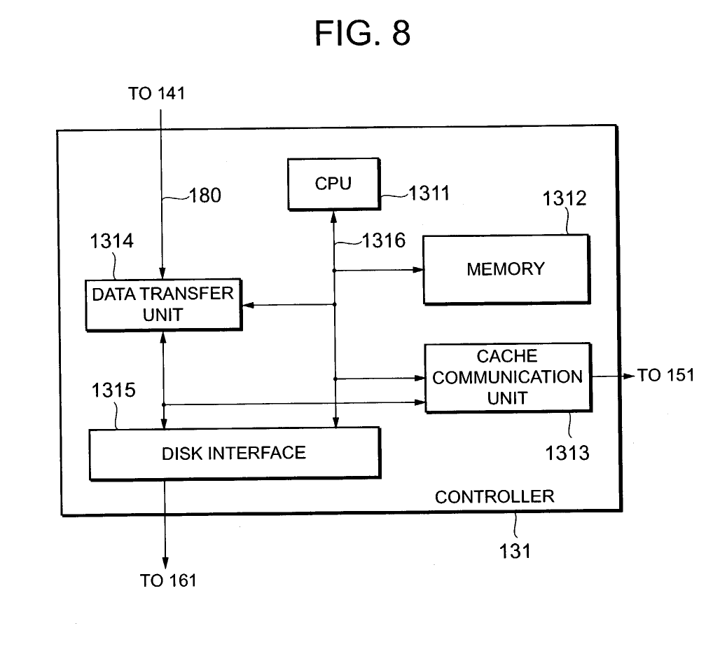

FIG. 8 shows an example of the internal configuration of the controller 131. The controller 132 has the similar configuration. In this example, the controller 131 comprises a CPU 1311 and the components connected to its bus 1316 such as a disk interface 1315, a memory 1312, a cache communication unit 1313, and a data transfer unit 1314 composed of a DMA (Dynamic Memory Access) controller and so on. The disk interface 1315 is the interface with the physical disk 161. The cache communication unit 1313 sends or receives data to or from the cache 151.

The data transfer unit 1314 sends or receives data to or from the host 111 via an internal bus 180 and, at the same time, sends or receives data to or from the cache memory 151 via the cache communication unit 1313 and to or from the disk 161 via the disk interface 1315. The memory 1312, composed of ROM and RAM, stores the controller program (including firmware) and so on. The CPU 1311 executes the controller program stored in the memory 1312 to control the overall controller and executes the functions required for the controller.

The controllers 131 and 132, each connected to separate hosts 111 and 112 via the ports 141 and 142 respectively, control data transfer according to a command request from the hosts 111 and 112. The physical disk 161 stores individual data 171 and 172 and shared data 173. The individual data 171 and 172 is data exclusively accessed by applications 121 and 122, respectively, running in the hosts 111 and 112.

In the description below, assume that the application 121 running in the host 111 frequently accesses the individual data 171 and that the application 122 running in the host 112 accesses the individual data 172 less frequently. In this situation, from the time the application 122 accesses the individual data 172 to the time it accesses the same data again, the application 121 accesses the individual data 171 many times.

This causes a conventional cache memory control unit, which manages the cache memory only with the LRU based page-out control, to allocate data of the individual data 171 one after another in the cache memory 151, resulting that data of the individual data 172 is paged-out. If this is the case, an access request from the application 122 always results in a cache miss and therefore the access becomes slow. The operation performance of the application 122 becomes significantly lower than the average performance of the disk array.

Even in such case, the cache memory control unit in this embodiment keeps a minimum number of cache pages for access via the port 142 to prevent data of the individual data 171 from being paged out. A predetermined hit ratio may be maintained even for an access request from the application 122.

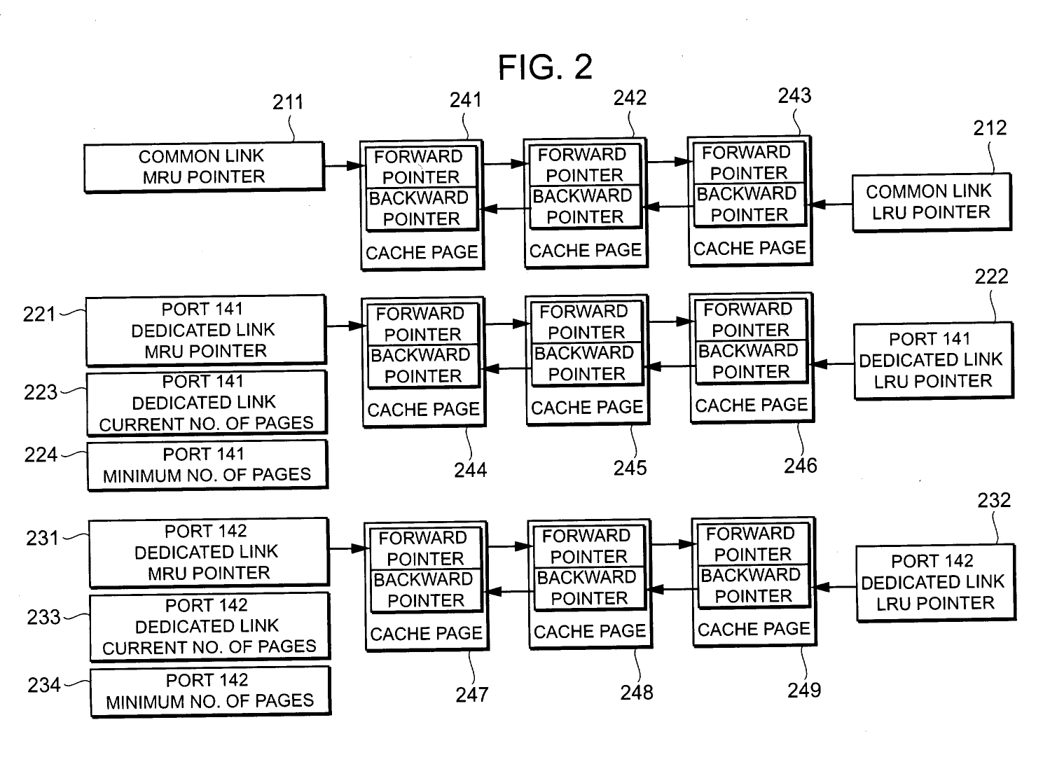

FIG. 2 is a block diagram showing an example of the internal logical configuration of the cache memory 151. The following describes this embodiment with reference to FIGS. 1 and 2.

The cache memory 151 comprises a plurality of cache pages 241-249 each used to store data. The plurality of cache pages 241-249 form LRU links. In this example, there are three types of LRU link: common LRU link, port 141 dedicated LRU link, and port 142 dedicated LRU link. Each of the cache pages 241-249 in the cache memory 151 belongs to one of those three types of LRU links. The link to which each cache page belongs to varies from time to time.

A forward link is formed such that a common link MRU (Most Recently Used) pointer 211 points to the cache page 241 and the forward pointer in the cache page 241 points to another cache page 242. Similarly, a backward link is formed beginning with a common link LRU pointer 212. That is, a two-way link, forward and backward, is formed. The cache page 241, which is pointed to by the MPU pointer, is the most recently accessed cache page in the link. On the other hand, the cache page 243, which is pointed to by the LRU pointer, is the least recently accessed cache page in the link and is a candidate for paging-out.

Similarly, the port 141 dedicated link is formed between the port 141 dedicated link MRU pointer 221 and the port 141 dedicated link LRU pointer 222. The port 142 dedicated link is formed between the port 142 dedicated link MRU pointer 231 and the port 142 dedicated link LRU pointer 232. These port dedicated links each have an area, 223 or 233, for storing the current number of pages and an area, 224 or 234, for storing the minimum number of pages.

Each current-number-of-pages area, 223 or 233, stores the total number of cache pages currently linked to the corresponding LRU link. Because three cache pages, 244, 245, and 246, are linked to the port 141 dedicated link, the value of 3 is stored in the current-number-of-pages area 223 of the port 141 dedicated link. Similarly, the value of 3 is stored in the current-number-of-pages area 233 of the port 142 dedicated link. Each minimum-number-of-pages area, 224 or 234, stores the minimum number of pages guaranteed for access via the corresponding port.

The application 121 running in the host 111 accesses the individual data 171 at a high frequency. The application 122 running in the host 112 accesses the individual data 172 at a relatively low frequency. Therefore, from the time the application 122 accesses data in the individual data 172 to the time it accesses the same data, the cache page allocation in the cache memory 151 changes greatly because the application 121 frequently accesses the individual data 171 during that period. The reason is that there is a great difference between the access frequency of the application 121 and that of the application 122.

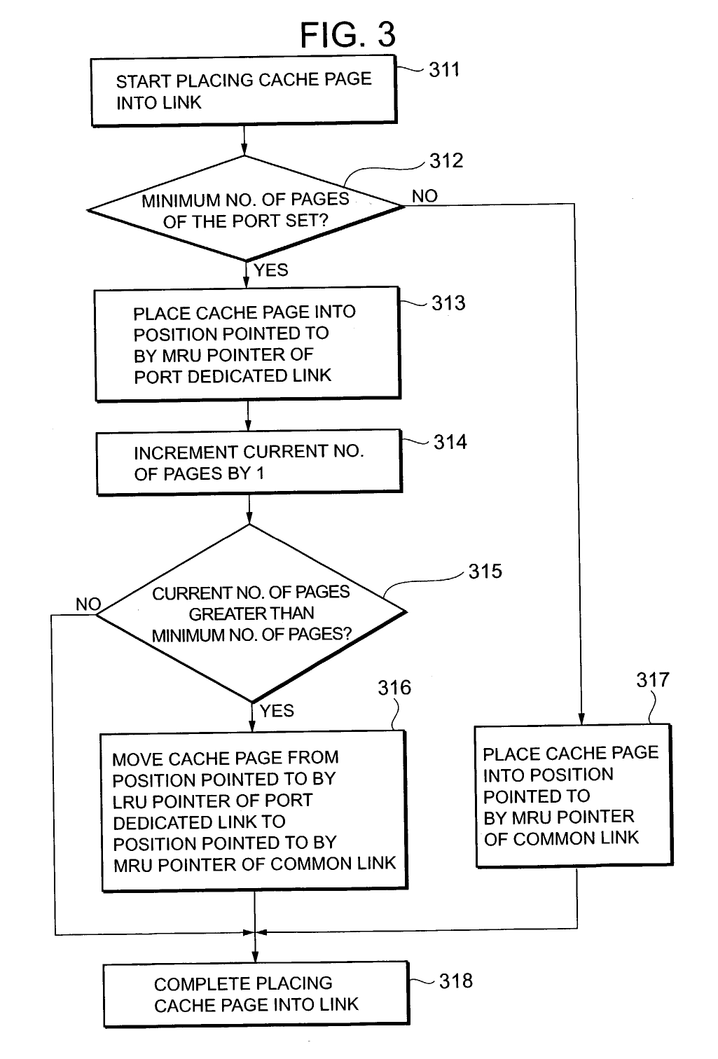

FIG. 3 is a flowchart showing an example of the operation executed by the cache memory control unit in this embodiment. The following describes the operation with reference to FIGS. 1-3.

When a data access request is issued from the host 111 or 112 and a cache hit occurs on the requested data, the cache page is removed from the LRU link and, after the data transfer is completed, the cache page is placed into the position pointed to by the MRU pointer of the corresponding link. On the other hand, when a data access request from the host 111 or 112 results in a cache miss, the cache page pointed to by the LRU pointer of the common link is paged out and the requested data is allocated to the cache page. The cache page to which the data is allocated is placed into the position pointed to by the MRU pointer of the corresponding link after the data transfer is completed as when a cache hit occurs.

Next, how the corresponding cache page is placed into the position pointed to by the MRU pointer of the corresponding link after data is transferred will be described with reference to FIG. 3. First, a check is made for the value of the minimum number of pages of the port (step 312). If the minimum number of pages is not set, that is, if the setting value is zero, the cache page is placed into the position pointed to by the MRU pointer of the common link (step 317). On the other hand, if the minimum number of pages is not zero, the cache page is placed into the position pointed to by the MRU pointer of the port dedicated link (step 313). Then, the value of the current number of pages in the dedicated link is incremented by 1 (step 314). Then, the current number of pages is compared with the minimum number of pages (step 315). If the comparison indicates that, after the cache page is added to the link, the current number of pages in the link exceeds the minimum number of pages, the excess number of cache pages is removed from the position pointed to by the LRU pointer and placed into the position pointed to by the MRU pointer of the common link (step 316).

This embodiment gives the following effect when the access frequency via the port 142 is low and when an access to the individual data 171 via the port 141 is made frequently from the time an access to the individual data 172 is made to the time the access is made to the same data again. The six cache pages, 241-246, are used repeatedly for the individual data 171. Therefore, the three cache pages, 247-249, are not paged out. This means that, when access is made to the individual data 172 later via the port 142, a cache hit occurs at least on data in the three cache pages, 247-249. Thus, the performance of the application 122 improves.

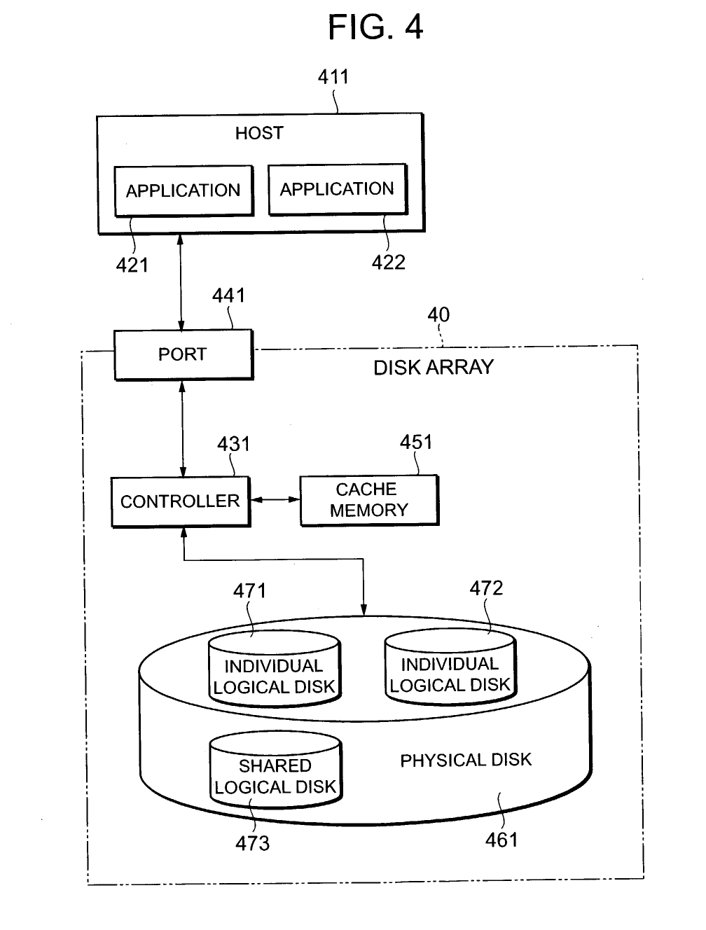

FIG. 4 is a block diagram showing a second embodiment of a cache memory control unit according to the present invention. The following describes the cache memory control unit with reference to this drawing.

The cache memory control unit in this embodiment is implemented by a program stored in a controller 431. The controller 431 is used for a small-capacity, high-speed cache memory 451 holding data, which is stored in a large-capacity, low-speed physical disk 461 but is frequently accessed by a host 411, and executes LRU control for the cache memory 451.

The internal hardware configuration of the controller 431 is the same as that of the controller 131 in the first embodiment shown in FIG. 8. The controller 431 has the following three functions: function to allocate, in the cache memory 451, individual cache pages for each access type as well as common cache pages regardless of access type, function to execute LRU control for individual cache pages and common cache pages, and function to load data, paged out from individual cache pages, into common cache pages. The access type is classified into access made to an individual logical disk 471 and access made to an individual logical disk 472.

A disk array 40 comprises a port 441, the controller 431, cache memory 451, and physical disk 461. The controller 431, composed of a CPU, ROM, RAM, input/output interface, and so on and connected to the host 411 via the port 441, controls data transfer according to a command request from the host 411. Although actually composed of a plurality of disk drives, the physical disk 461 is represented by one disk drive in the figure. The physical disk 461 includes the individual logical disks 471 and 472 and a shared logical disk 473. The individual logical disks 471 and 472 are each a storage space accessed exclusively by applications 421 and 422, respectively, in the host 411.

In this embodiment, the separate applications 421 and 422 access individual data from the same host 411. That is, the two applications 421 and 422 are running in one host 411. In the description below, assume that the application 421 accesses the individual logical disk 471, logically built in the physical disk 461, at a high frequency. The individual logical disk 471 is a data area accessed primarily by the application 421. Also assume that the application 422 accesses the individual logical disk 472 at a low frequency. The individual logical disk 472 is a data area accessed primarily by the application 422.

In this configuration, access cannot be classified according to the port because all accesses are made via the single port 441. However, because the applications 421 and 422 access predetermined individual logical disks 471 and 472, cache page allocation in the cache memory 451 is managed for each of the individual logical disks 471 and 472.

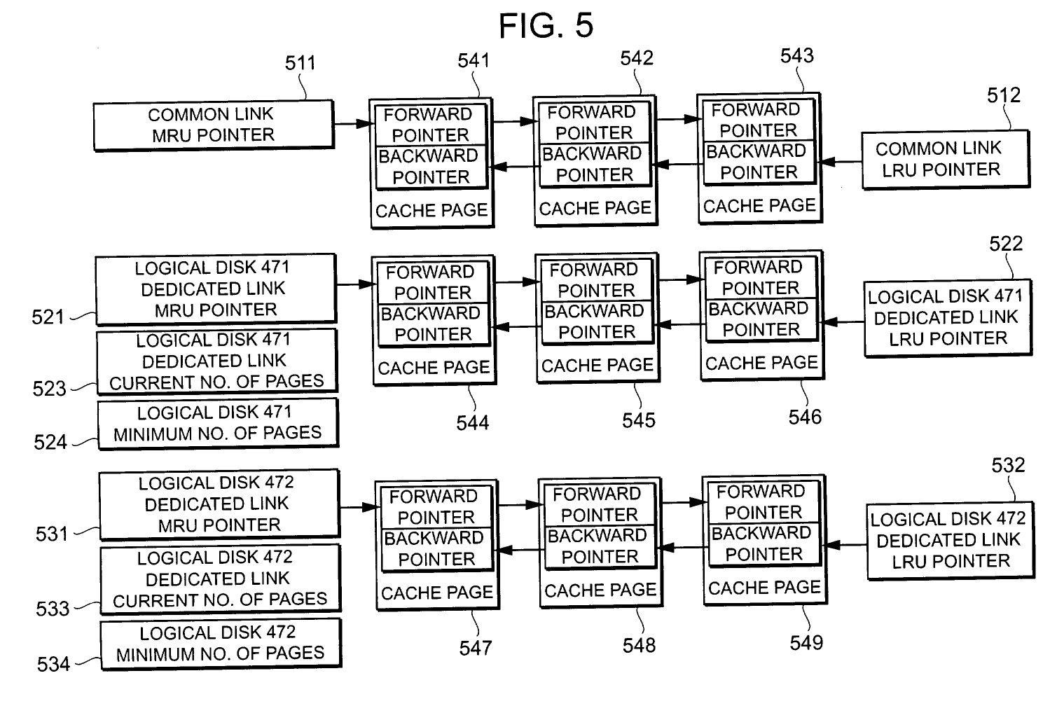

FIG. 5 is a block diagram showing an example of the internal logical configuration of the cache memory 451. The following describes this configuration with reference to FIGS. 4 and 5.

As compared with the example in the first embodiment, the internal logical configuration of the cache memory 451 is the same in the common link beginning with the common link MRU pointer 511 and ending the common link LRU pointer 512 but is different in that the dedicated link is a logical disk dedicated link. The value of the current number of pages 523 of the link dedicated to the logical disk 471 is the number of cache pages linked between the MRU pointer 521 of the link dedicated to the logical disk 471 to the LRU pointer 522 of the link dedicated to the logical disk 471. The value of the current number of pages 523 of the link dedicated to the logical disk 471 is managed by the minimum number of pages 524 of the logical disk 471 and therefore at least the minimum number of pages are guaranteed in the dedicated link. This configuration keeps the predetermined amount of data of the individual logical disk 472 in the cache, thus avoiding an extreme performance degradation of the application 422.

The cache memory control unit and control method according to the present invention prevent the performance from being extremely degraded in a multi-host environment even when the frequency of data access from one host is lower than the frequency of data access from another host and the hit ratio of the lower-access-frequency host becomes almost zero. This is because a minimum cache capacity allocated to an access from a host connected to a specified port ensures a minimum hit ratio. In addition, even when a plurality of applications in the same host access separate data and the access frequency varies greatly between those applications, the cache memory control unit and control method according to the present invention maintain the access performance of a lower-access frequency application.

While this invention has been described with reference to illustrative embodiments, this description is not intended to be construed in a limiting sense. Various modifications of the illustrative embodiments as well as other embodiments of the invention, will be apparent to persons skilled in the art upon reference to this description. It is, therefore, contemplated that the appended claims will cover any such modifications or embodiments as fall within the true scope of the invention.

What is claimed is:

1. A cache memory control unit that is used for a small-capacity, high-speed cache memory holding data, which is stored in a large-capacity, low-speed storage unit but is frequently accessed by a computer, and that executes LRU (Least Recently Used) control for the cache memory, said cache memory control unit comprising:
means for allocating, in said cache memory, individual cache pages to each access type and allocating common cache pages regardless of the access type;
means for executing the LRU control for each of the individual cache pages and the common cache pages; and
means for loading data, which is paged out from the individual cache pages, into the common cache pages.

2. The cache memory control unit according to claim 1,
wherein the access type is classified according to a port via which data is accessed.

3. The cache memory control unit according to claim 1,
wherein the access type is classified according to a storage space in said storage unit to which access is made.

4. The cache memory control unit according to claim 2,
wherein the individual cache pages and the common cache pages each form an LRU link in which pages, beginning with a page pointed to by an MRU (Most Recently Used) pointer and ending with a page pointed to by an LRU pointer, are connected via pointers, said MRU pointer pointing to a most recently accessed cache page in the LRU link, said LRU pointer pointing to a least recently accessed cache page, and
wherein, when requested data results in a cache miss, a cache page pointed to by the LRU pointer of a common link is paged out and a cache page, to which the requested data is allocated, is placed into a position pointed to by the MRU pointer of the LRU link of corresponding individual cache pages.

5. The cache memory control unit according to claim 4,
wherein, when a number of linked cache pages of each port exceeds a number of cache pages predetermined for the port, an excess number of cache pages is removed from a position pointed to by the LRU pointer and placed into a position pointed to by the MRU pointer of the common cache pages.

6. The cache memory control unit according to claim 3,
wherein the individual cache pages and the common cache pages each form an LRU link in which pages, beginning with a page pointed to by an MRU (Most Recently Used) pointer and ending with a page pointed to by an LRU pointer, are connected via pointers, said MRU pointer pointing to a most recently accessed cache page, said LRU pointer pointing to a least recently accessed cache page, and
wherein, when requested data results in a cache miss, a cache page pointed to by the LRU pointer of a common link is paged out and a cache page, to which the requested data is allocated, is placed into a position pointed to by the MRU pointer of the LRU link of corresponding individual cache pages.

7. The cache memory control unit according to claim 6,
wherein, when a number of linked cache pages of each storage space exceeds a number of cache pages predetermined for the storage space, an excess number of cache pages is removed from a position pointed to by the LRU pointer and placed into a position pointed to by the MRU pointer of the common cache pages.

8. The cache memory control unit according to claim 2,
wherein said storage unit is a disk array.

9. The cache memory control unit according to claim 3,
wherein said storage unit is a disk array.

10. A cache memory control method that is used for a small-capacity, high-speed cache memory holding data, which is stored in a large-capacity, low-speed storage unit but is frequently accessed by a computer, and that executes LRU control for the cache memory, said cache memory control method comprising the steps of:
(a) allocating, in said cache memory, individual cache pages to each access type and allocating common cache pages regardless of the access type;
(b) executing the LRU control for each of the individual cache pages and the common cache pages; and
(c) loading data, which is paged out from the individual cache pages, into the common cache pages.

11. The cache memory control method according to claim 10,
wherein the access type is classified according to a port via which data is accessed.

12. The cache memory control method according to claim 10,
wherein the access type is classified according to a storage space in said storage unit to which access is made.

13. The cache memory control method according to claim 11,
wherein the individual cache pages and the common cache pages each form an LRU link in which pages, beginning with a page pointed to by an MRU pointer and ending with a page pointed to by an LRU pointer, are connected via pointers, said MRU pointer pointing to a most recently accessed cache page in the LRU link, said LRU pointer pointing to a least recently accessed cache page, and
wherein, when requested data results in a cache miss, said step (c) comprises the steps of paging out a cache page pointed to by the LRU pointer of a common link; and placing a cache page, to which the requested data is allocated, into a position pointed to by the MRU pointer of the LRU link of corresponding individual cache pages.

14. The cache memory control method according to claim 13,
wherein, when a number of linked cache pages of each port exceeds a number of cache pages predetermined for the port, said step (c) comprises the steps of removing an excess number of cache pages from a position pointed to by the LRU pointer; and placing the cache page into a position pointed to by the MRU pointer of the common cache pages.

15. The cache memory control method according to claim 12,
wherein the individual cache pages and the common cache pages each form an LRU link in which pages, beginning with a page pointed to by an MRU pointer and ending with a page pointed to by an LRU pointer, are connected via pointers, said MRU pointer pointing to a most recently accessed cache page, said LRU pointer pointing to a least recently accessed cache page, and
wherein, when requested data results in a cache miss, said step (c) comprises the steps of paging out a cache page pointed to by the LRU pointer of a common link; and placing a cache page, to which the requested data is allocated, into a position pointed to by the MRU pointer of the LRU link of corresponding individual cache pages.

16. The cache memory control method according to claim 15,
wherein, when a number of linked cache pages of each storage space exceeds a number of cache pages predetermined for the storage space, said step (c) comprises the steps of removing an excess number of cache pages from a position pointed to by the LRU pointer; and placing the cache page into a position pointed to by the MRU pointer of the common cache pages.

17. The cache memory control method according to claim 11,
wherein said storage unit is a disk array.

18. The cache memory control method according to claim 12,
wherein said storage unit is a disk array.
